(19) United States
(12) Patent Application Publication
(10) Pub. No.: US 2023/0149957 A1
(43) Pub. Date: May 18, 2023

(54) HAZER

(71) Applicant: Z-Image, LLC, Firestone, CO (US)

(72) Inventors: Ted ZIEMKOWSKI, Firestone, CO (US); John BONVALLET, Boulder, CO (US)

(21) Appl. No.: 17/454,950

(22) Filed: Nov. 15, 2021

(51) Int. Cl. B05B 7/16; B05B 7/22; B05B 12/08

(52) U.S. Cl. CPC B05B 7/1686; B05B 7/1606; B05B 7/22; B05B 12/08

(57) ABSTRACT

A hazer, method of controlling a hazer, and a system including one or more hazers are provided. The hazer includes a peristaltic pump, a heater, and a controller coupled to the peristaltic pump and the heater. During hazer operation, the controller actuates the peristaltic pump to pump fluid into the heater, and causes the heater to vaporize the fluid to form a haze. The controller may similarly actuate the pump and heater in each hazer of the system to form haze. In this way, more consistent pump operation and less pump failure rates may be observed in contrast to piston pumps. Additionally, the hazer may include various other features including at least one of an air pump with variable flow rate, a fan with tachometer for detecting fan errors, RDM error reporting, low voltages, a fan sponge, a pressure sensor, OTD for determining heater errors, and HVAC attachments.

### BACKGROUND

### Field

The present disclosure generally relates to a device which produces atmospheric effects, and more specifically to a hazer.

### INTRODUCTION

Hazers, also referred to as haze machines or haze generators, are devices which produce haze. In contrast to the dense vapor produced by fog machines, haze tends to be lighter and more subtle and can remain in the air for hours at a time. Haze may also provide a Tyndall Effect, in which beams of light passing through the haze scatter and their paths become visible. As a result, hazers have primarily been used for atmospheric effects in theatrical (e.g., stage lighting), music (e.g., DJ effects), amusement (e.g., laser maze or laser tag), and other commercial settings. Additionally, hazers have been used to provide sanitization in industrial settings.

### SUMMARY

Several aspects relating to hazers will be described more fully hereinafter.

In one aspect, a hazer is provided. The hazer comprises a peristaltic pump, a heater, and a controller coupled to the peristaltic pump and to the heater. The controller is configured to actuate the peristaltic pump to pump fluid into the heater, and to cause the heater to vaporize the fluid to form a haze.

In another aspect, a method of controlling a hazer is provided. The method comprises actuating a peristaltic pump to pump fluid from a fluid tank into a heater, and causing the heater to vaporize the fluid to form a haze.

In a further aspect, a system is provided. The system comprises one or more hazers each including a peristaltic pump and a heater, and a controller coupled to the one or more hazers. The controller is configured, for each of the one or more hazers, to actuate the peristaltic pump to pump fluid into the heater, and to cause the heater to vaporize the fluid and form a haze.

Other aspects will become readily apparent to those skilled in the art from the following detailed description, wherein is shown and described only several embodiments by way of illustration. As will be realized by those skilled in the art, concepts herein are capable of other and different embodiments, and several details are capable of modification in various other respects, all without departing from the present disclosure. Accordingly, the drawings and detailed description are to be regarded as illustrative in nature and not as restrictive.

### BRIEF DESCRIPTION OF THE DRAWINGS

Various aspects will now be presented in the detailed description by way of example, and not by way of limitation, in the accompanying drawings, wherein:

FIG. 1 illustrates a schematic view of various components of an example hazer.

FIGS. 2A-2B illustrate perspective views of the example hazer of FIG. 1.

FIG. 3 illustrates a perspective view of a heater in the example hazer of FIG. 1.

FIG. 4 illustrates a schematic view of an example system including multiple hazers.

FIGS. 5A-5B illustrate perspective views of an example hazer attached to an air duct in a heating, ventilation, and air conditioning (HVAC) system.

FIG. 6 illustrates a flow diagram of a method for controlling an example hazer.

FIG. 7 illustrates a flow diagram of another method for controlling an example hazer.

FIG. 8 is a block diagram of an example controller processing system configured to execute one or more sets of instructions for hazer operations.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The words “exemplary” and “example” are used herein to mean serving as an example, instance, or illustration. Any exemplary embodiment described herein as “exemplary” is not necessarily to be construed as preferred or advantageous over other exemplary embodiments. Likewise, the term “exemplary embodiment” of an apparatus, method or article of manufacture does not require that all exemplary embodiments of the invention include the described components, structure, features, functionality, processes, advantages, benefits, or modes of operation.

As used herein, the term “coupled” is used to indicate either a direct connection between two components or, where appropriate, an indirect connection to one another through intervening or intermediate components. In contrast, when a component referred to as being “directly coupled” to another component, there are no intervening elements present.

In the following detailed description, various aspects of a hazer will be presented. These aspects are well suited for hazers applied in commercial settings such as laser mazes, laser tag arena, theater, music, or other venues. However, those skilled in the art will realize that these aspects may be extended to hazers applied in industrial settings, such as for sanitizing an environment. Accordingly, any reference to a specific apparatus or method is intended only to illustrate the various aspects of the present invention, with the understanding that such aspects may have a wide range of applications without departing from the spirit and scope of the present disclosure.

Typically, hazers include piston pumps, which contract and expand a cavity containing fluid (e.g., water-based haze) in a reciprocating manner in order to pump the fluid through the hazer. The piston pump utilizes a check valve in order to flow the fluid or material. The check valve prevents flowing in a reverse direction and thus does not allow for un-priming. However, due to frequent or constant contact between the fluid and the mechanical components of the piston pump and the check valves, corrosion of these mechanical components may occur over time, diminishing their effect and requiring frequent replacement of the piston pump for hazer operation. Moreover, due to different piston pump tolerances or other factors, replacing the piston pump may change fluid flow rates, resulting in the hazer outputting different amounts of haze over time notwithstanding a same haze output setting.

Accordingly, to address this problem of conventional hazers, in an aspect of the present disclosure, the hazer may include a peristaltic pump which pumps fluid through a tube in the hazer in a rotary manner. A controller of the hazer may actuate a rotor with rollers in the peristaltic pump to rotate in a stepped manner (in partial revolutions or steps) and compress the tube, causing the fluid to move through the tube towards the pump outlet. Since the rollers do not directly contact the fluid and instead contact the tube (unlike in piston pumps), the risk of mechanical corrosion in the pump may be minimized, improving the longevity of the pump and requiring less frequent replacement if at all. Moreover, unlike in piston pumps, replacement (new) peristaltic pumps may output a same amount of haze over time compared to replaced (old) peristaltic pumps without changing haze output settings. Furthermore, as the fluid in the peristaltic pump only moves in response torotation of the rotor, leaks may be prevented if hazer components on the inlet or outlet side of the pump are detached (e.g., the fluid tank, heater, etc.). Thus, the rollers effectively serve as bidirectional check valves on the inlet and outlet sides of the pump, thereby allowing the hazer to function without the physical check valves typically accompanying piston pumps. This feature of the peristaltic pump also allows for un-priming (e.g., pumping all the fluid out of the hazer and back into the fluid tank) since the peristaltic pump can run in both directions in contrast to piston pumps.

Moreover, in other aspects of the present disclosure, the hazer may include other features (alternatively or additionally to the peristaltic pump) that solve problems associated with conventional hazers. In one example, conventional hazers typically include air pumps (e.g., vibrating pumps) which output a fixed rate of air flow. As a result, these hazers inefficiently output the same amount of air during different modes of hazer operation, for example, when the hazer is warming up, outputting haze, or cleaning. To address this inefficiency, in an aspect of the present disclosure, the hazer may include an air pump which rate of air flow the controller may adjust using pulse-width modulation (PWM). For example, the controller may control the air pump to output air at different flow rates in response to different electrical pulse widths (e.g., one flow rate during warm up, another flow rate during haze output, and another flow rate during cleaning), thereby allowing different air flow rates to be efficiently applied for different hazer functions.

In another example, according to an aspect of the present disclosure, the hazer may include a fan which circulates air to blow haze out of the hazer. However, sometimes haze output may be caught by the fan and re-circulated into the hazer. As a result, fluid condensation may accumulate in the fan along with dust, slowing down the fan and causing the fan to operate at lower speeds than initially set. If a significant amount of fluid condensation and dust is accumulated, the fan may even cease to function altogether or may function at below minimum speeds for proper hazer operation, thus requiring fan replacement. To address this problem, in an aspect of the present disclosure, the fan may include a tachometer which measures a current speed of the fan. The controller may obtain the measurement from the tachometer and determine whether the speed measurement is less than a set fan speed or a minimum fan speed, in response to which the controller may indicate to the user (e.g., output a light, message, or other indicator) that the fan is not operating correctly and thus may require speed adjustment, cleaning, or eventual replacement.
In this way, the controller may notify the user in advance of a possible problem with the fan and take remedial action accordingly. Additionally, in another aspect of the present disclosure, the hazer may include a sponge positioned underneath the fan (referred to herein as a fan sponge), which may catch droplets of condensed fluid (haze) from the fan and thus prevent accumulation of liquid in the hazer. Similarly, in a further aspect of the present disclosure, the hazer may include a sponge located at the hazer output (referred to herein as an output sponge) which may catch droplets of fluid at the haze output.

In a further example, in an aspect of the present disclosure, the hazermay provide digital multiplex (DMX) communication capabilities. Generally in DMX, a controller (e.g., in a lighting control console, a personal computer, etc.) may communicate data in different DMX channels to a DMX device via a DMX connector or port (e.g., 3-pin or 5-pin XLR ports or an 8-pin RJ-45 port), and the DMX device may perform a given function according to the data received in a respective DMX channel. For instance, DMX devices may be capable of receiving data over 512 different DMX channels, where each channel carries 8 bits of data (e.g., a value between 0 and 255 or some other value), and the DMX device may adjust an intensity of light or special effect corresponding to a given DMX channel according to the value of the received data in that channel. For instance, in one aspect of the present disclosure, a controller (e.g., in the hazer, lighting control console, personal computer, etc.) may instruct the hazer to adjust haze output amount in one DMX channel, fan speed in another DMX channel, etc. However, as DMX allows for only one-way communication (e.g., between the controller and the DMX device), feedback may not be provided to the controller regarding the hazer's various functions. Thus, a user may not be able to determine from hazers solely incorporating DMX whether an error in the fan, a fluid tank connected to the hazer, a heater in the hazer, or other component of the hazer has occurred. To address this deficiency, according to another aspect of the present disclosure, the controller may be configured to perform remote device management (RDM). RDM expands DMX to include bi-directional communication between the controller and DMX devices over existing DMX lines. Thus in RDM, the controller may send queries or messages to different components of the hazer (e.g., the fan, fluid tank, heater, etc.) querying a respective status, and the queried component may provide feedback such as an error report to the controller in response to the message. For example, the hazer may report to the controller whether a fan is not working correctly (e.g., only working at half its rated speed), whether fluid in the fluid tank is empty (e.g., based on fluid metering of the peristaltic pump), whether a thermocouple in the heater is open, and the like. Thus, the hazer may allow for proactive remedial measures to be taken (e.g., part ordering and replacement) in response to error reporting through RDM.

Moreover, in another aspect of the present disclosure, multiple hazers may be connected to each other in a master-slave arrangement, where one hazer is the master device and the other hazers are connected together in a daisy-chain fashion as slave devices. For example, a controller and a hazer (e.g., a master hazer) may communicate with each other in DMX or RDM via DMX connectors or ports over a bus or interface (e.g., an RS-485 bus), and the master hazer may communicate with another hazer (e.g., a slave hazer) in DMX or RDM similarly via DMX connectors over the bus. Similarly, slave hazers may communicate with other slave hazers via DMX or RDM over the bus. In such arrangement, if the controller communicates DMX or RDM messages with the master hazer such as described above (e.g., haze output settings, fan speed settings, error report queries, etc.), the master hazer may pass duplicate or similar messages to, or receive these messages from, a slave hazer via DMX or RDM, which in turn may pass duplicate or similar messages to, or receive these messages from, another slave hazer via DMX or RDM, and so forth. Thus, in situations where multiple hazers are connected together in a system according to a master-slave architecture, the controller may simply communicate with one hazer (the master hazer) in order to control operation of, or receive error reporting from, the other hazers in the system. In this way, DMX and RDM communication may be simplified in situations where multiple hazers are used, since the controller does not need to communicate directly with all hazers over multiple interfacesin order to control their functions or receive error reports.

In another example, conventional hazers typically operate with alternating current (AC) power, and thus include high voltages. For instance, these hazers may be directly plugged into a wall outlet, and its components may operate with voltages between 115 and 230 V. As such high voltages may result in shock to a user upon contact with wires or other components in these hazers, the hazers may typically be accompanied with high voltage warnings that instruct users not to open the hazer or service its parts. As a result, if a component of the hazer malfunctions or requires replacement, the entire hazer likely needs to be replaced, which is cost ineffective. Moreover, some conventional hazers may include internal power supplies (e.g., voltage sources internal to the hazer), which may result in frequent power failures. For example, if output haze is captured by a fan and re-circulated into the hazer, the haze may contact the internal power supply, potentially resulting in short circuits and subsequent power failures. To address these issues, according to various aspects of the present disclosure, the hazer may operate with direct current (DC) power at low voltages (e.g., 12-15 V). For example, the hazer may be connected to an external power supply adapter, which converts high-voltage AC power (e.g., from a wall outlet) to low-voltage DC power. The external adapter may be sealed to protect its contents or electronics from haze, thus minimizing the risk of power failures and facilitating adapter servicing or replacement in the unlikely event of a power failure. Alternatively, the hazer may be connected to an external battery, such as a car battery, which provides similar low voltages (e.g., 15 V). As a result of these lower voltages associated with DC power, the risk of shock to the user upon contact with hazer components is significantly reduced, and therefore the user may safely open the hazer to service or replace its components without having to replace the entire hazer. Thus, in one aspect of the present disclosure, the hazer may be modular and allow for individual component serviceability (e.g., as a result of DC power supplied). Moreover, in one aspect of the present disclosure, the hazer may include a tool holder which holds a tool such as a screw driver (e.g., a T20 Torx® screw driver or some other brand screw driver or tool), and the user may use this tool to open the hazer and remove, replace, and attach the various components of the hazer.

In a further example, conventional hazers typically include heaters for vaporizing fluid into haze that operate at high power (e.g., 375 W, 750 W, or even 1000-1100 W) or have a large heater area. For example, such heaters may carry long, copper heating coils that take a significant amount of time to heat the large area of the heater with significant consumption of power. Accordingly, to save power and heating time, in a further aspect of the present disclosure, the hazer may include a low power heater (e.g., a micro heater) such as a cartridge heater, which includes a smaller area for heating fluid entering the heater through the tube from the peristaltic pump. The cartridge heater may be enclosed in a structure such as a block or box attached to a printed circuit board (PCB), and a thermocouple may be coupled to the heater which senses the temperature of the fluid within the box or other structure. The hazer may also incorporate open thermocouple detection (OTD), such as a standard OTD circuit which detects open-circuit faults, to determine if a heater error occurs. For example, if a thermocouple breaks from heat or stress and results in an open-circuit, the controller may detect a large increase in voltage with respect to a reference voltage across a measuring junction of the thermocouple, in response to which the controller may subsequently determine that a heater error has occurred. The controller may then notify the user of the error, for example, by indicating a light, sound effect, or other output of the hazer or by communicating DMX/RDM feedback to an external controller (e.g., in a master-slave arrangement) that a heater error has occurred.

In another aspect of the present disclosure, the hazer may include a pressure sensor coupled to the tube which senses air pressure inside the tube. The pressure sensor may detect an increase in pressure, for example, when fluid enters the tube from the peristaltic pump (e.g., after a number of partial revolutions or steps), or when carbon build-up from fluid results in a blockage or plugging of the tube or heater. Based on the pressure sensed by the pressure sensor, the controller may determine whether the hazer successfully operates. For example, if the controller determines a slight increase in pressure is periodically sensed by the pressure sensor (e.g., after a number of partial revolutions of the rotor in the peristaltic pump), the controller may determine that fluid is correctly being pumped into the tube and heater. On the other hand, if the controller determines a significant increase in pressure in the tube from the pressure sensor, the controller may determine that such increase in pressure may result from a clogged tube or heater (e.g., due to carbon build-up) or insufficient air flow, and the controller may indicate to the user that the air pump, tube or heater needs to be replaced. For example, the controller may indicate a light, sound effect, or other output on the hazer, or the controller may communicate DMX/RDM feedback to an external controller (e.g., in a master-slave arrangement) that an error has occurred with the air pump, tube or heater.

In an additional aspect of the present disclosure, the hazer may be connected to an HVAC system and triggered to operate in response to air flowing through the HVAC system. For example, rather than incorporating a fan in the hazer, in this aspect of the present disclosure, an inlet of the hazer may be attached to an air duct to capture air flowing through the duct. To conserve power when the HVAC system is inactive (e.g., when no air flows through the duct), the hazer may include a vane switch (or other switch) that triggers in response to air flow. When the switch triggers, the controller may apply power to the peristaltic pump, air pump, heater, and other components of the hazer to enable hazer operation; otherwise, the controller may not apply power to these components. The hazer may thus output haze in response to HVAC air flow. In another aspect, an outlet of the hazer may similarly be attached to the air duct in order to release haze into the duct. In this way, haze may efficiently flow through a venue's HVAC system, thereby filling an area with haze through air vents in various commercial or industrial settings.

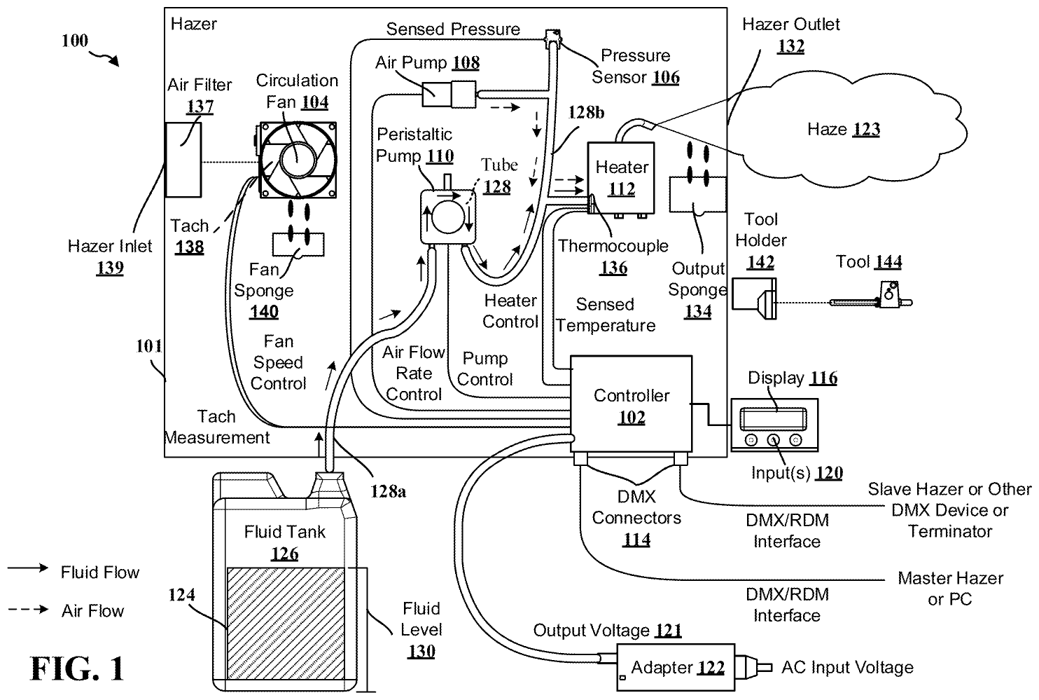

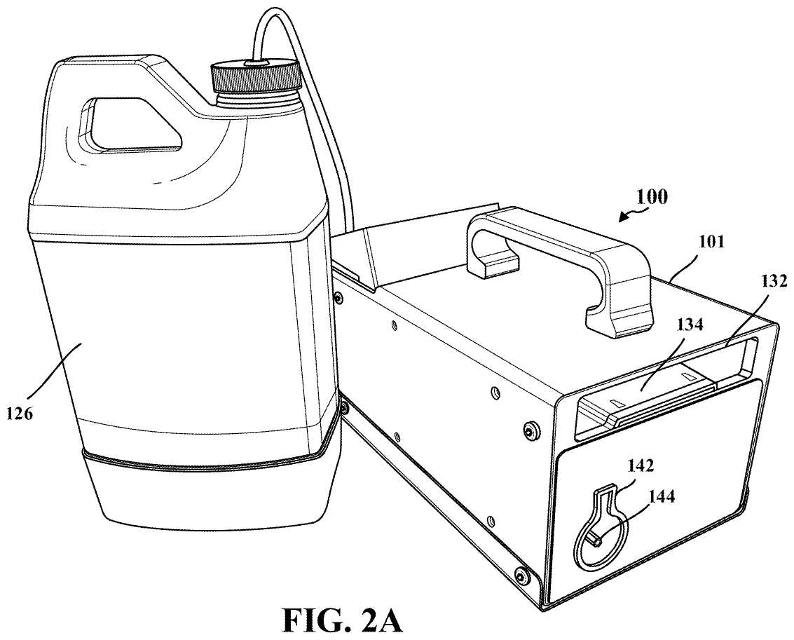

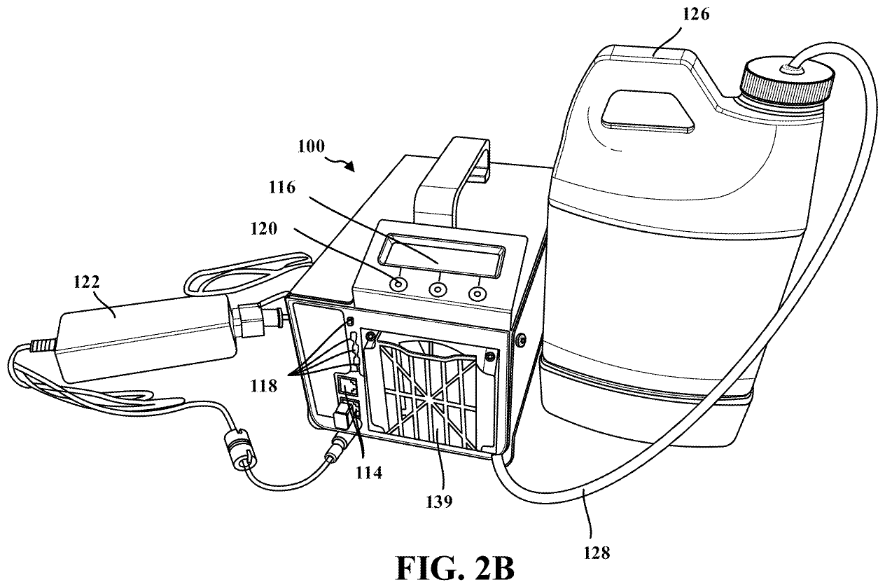

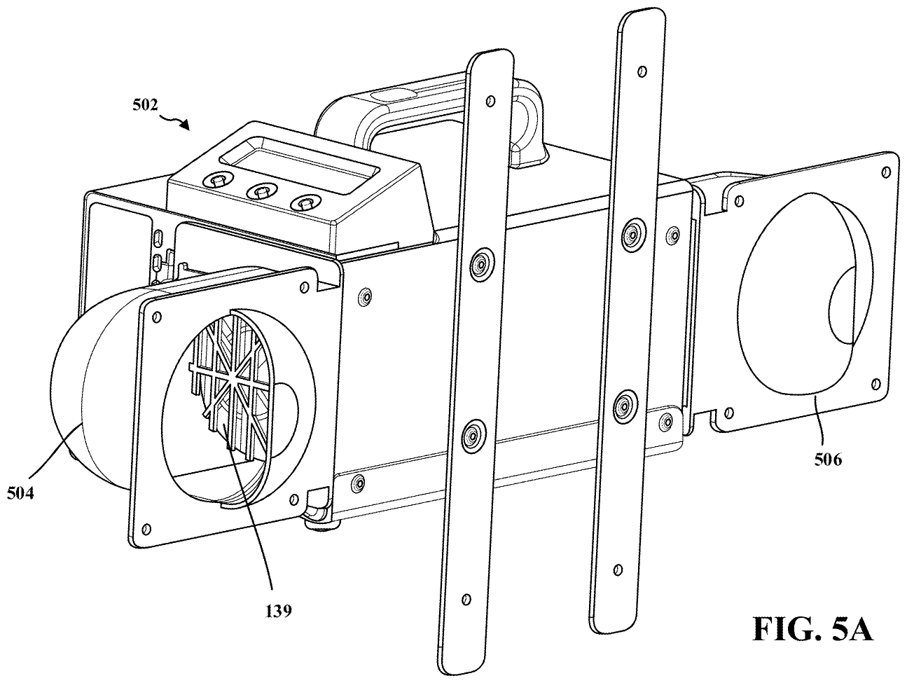

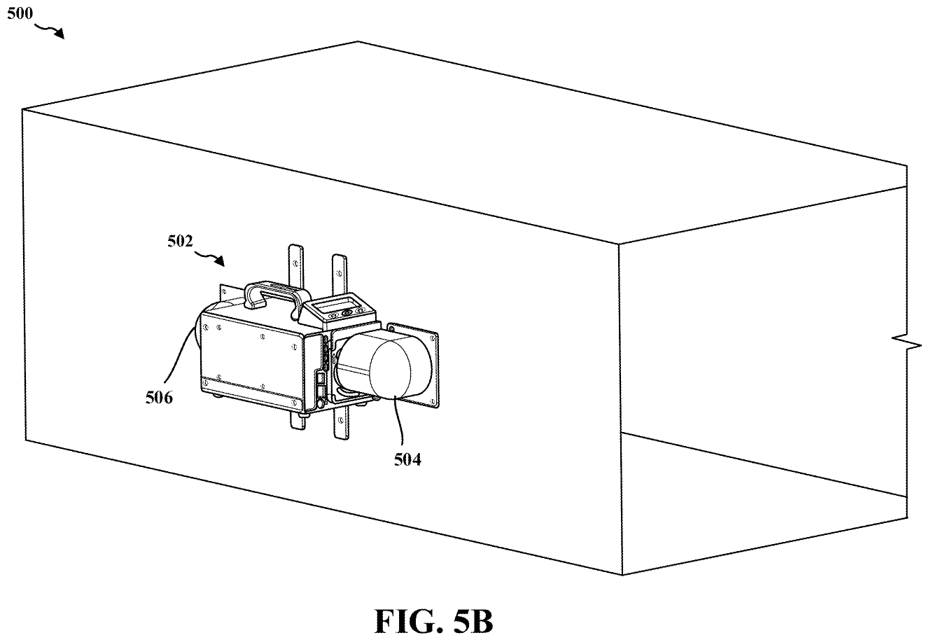

FIGS. 1, 2A, and 2B illustrate an example of a hazer 100 according to various aspects of the present disclosure. In one aspect, the hazer may include a housing 101 containing a controller 102 which is configured to perform the various functions of the hazer described throughout this disclosure. In this aspect, the controller may be internal to the hazer, such as illustrated in FIG. 1. The internal controller may be coupled to various components of the hazer, including, but not limited to, a fan 104, a pressure sensor 106, an air pump 108, a peristaltic pump 110, a heater 112, DMX connector(s) 114, an output display 116 and indicator(s) 118, and one or more inputs 120 (which may be separate from or combined with display 116). In some aspects, the hazer may not include all of these components; for example, the hazer may not include a fan if connected to an HVAC system such as illustrated in FIGS. 5A-5B.

In various aspects, the controller 102 may also be coupled to a power supply adapter 122. The power supply adapter may include standard power circuitry that transforms higher-voltage, AC power supplied from a power source through a wall outlet (e.g., an AC input voltage such as illustrated in FIG. 1) into lower-voltage, DC power for the controller and the various components of the hazer to operate as described above. As a result of the lower voltage (e.g., an output voltage 121 of 12 V-15 V), the hazer allows for users to service its components without risk of electric shock, in contrast to conventional hazers which typically operate under higher voltagesand thus indicate to users not to service their components for safety. Moreover, unlike conventional hazers which include internal power supplies that are difficult to replace and include un-sealed (not enclosed) power circuitry that are capable of contact with re-circulated haze, the power supply adapter 122 here is external to the hazer to allow for easy replacement and encloses or seals its power circuitry to protect the circuitry from output haze. In other aspects, the controller may be coupled to a battery (not shown) which provides low voltage DC power (e.g., the output voltage 121).

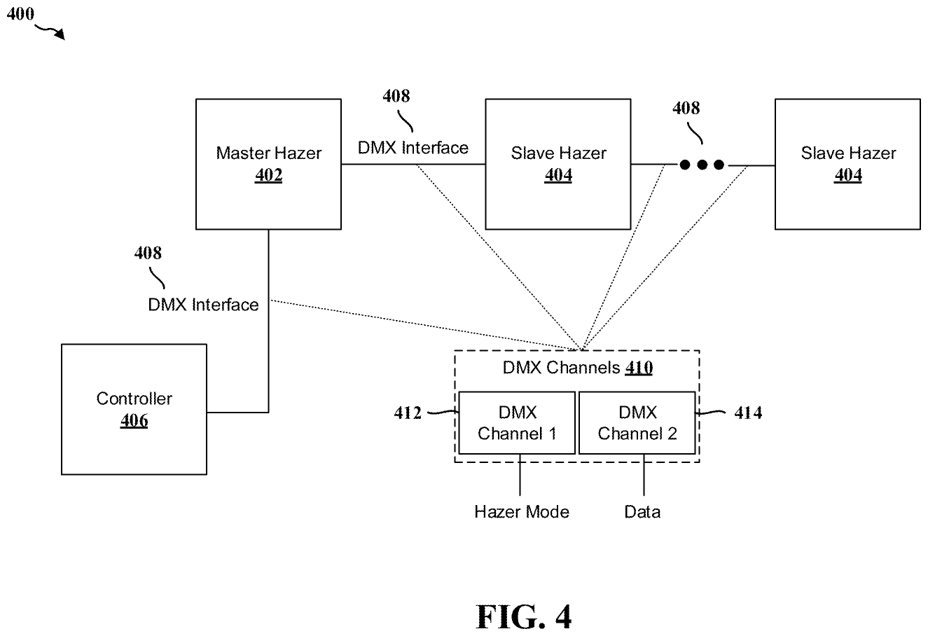

The internal controller may execute various instructions to operate or control the hazer. For example, the internal controller may set fan speeds, obtain fan tachometer measurements, sense a pressure detected by the pressure sensor, adjust air flow rate of the air pump, actuate the peristaltic pump to pump fluid, supply power to the heater to vaporize fluid into haze 123, communicate with an external controller (e.g., a controller in a lighting control console, personal computer, etc. that is external to the hazer) or another hazer (e.g., a master or slave hazer) via DMX or RDM through the DMX connector(s), output visual information or sound effects on the output display or indicators, or receive user inputs such as haze output levels or fan speeds (e.g., via the inputs or through DMX connector(s)). This list of functions is not intended to be exhaustive; the controller may also perform other or different functions in the hazer than those listed. Moreover, the controller may not perform all the listed functions; for example, the controller may not set fan speeds or obtain fan tachometer measurements in aspects where the hazer does not include the fan. In another aspect, an external controller (e.g., a controller in a lighting control console, personal computer, etc. that is external to the hazer, such as illustrated in FIG. 4) may execute instructions to operate or control the hazer. For example, the external controller may transmit one or more messages to controller 102 of hazer 100 through DMX or RDM communication instructing the internal controller to perform one or more of the aforementioned functions, which internal controller in turn may perform any one or more of the aforementioned functions in response to the message(s).

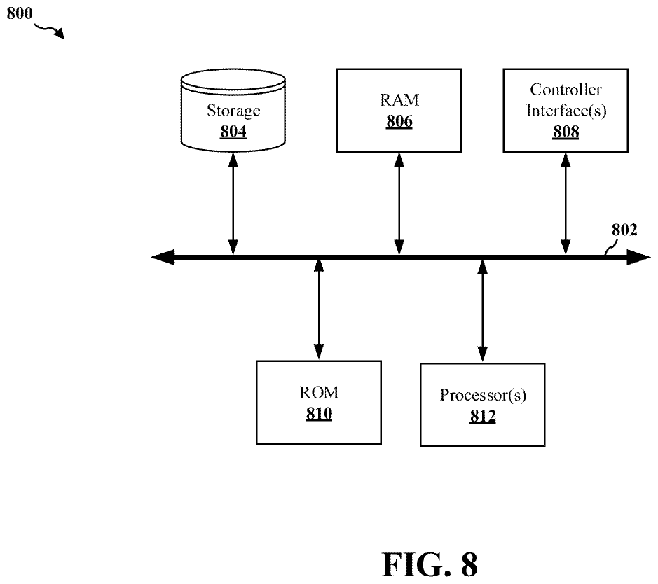

The controller (e.g., controller 102 and/or the external controller in FIG. 4) may include circuitry such as one or more processors for executing instructions and may include either a microcontroller, a microprocessor, a Digital Signal Processor (DSP), an Application-Specific Integrated Circuit (ASIC), a Field Programmable Gate Array (FPGA), hard-wired logic, analog circuitry and/or a combination thereof. The controller and its components may be implemented with embedded software or firmware that performs the various functions of the controller described throughout this disclosure. Alternatively, software or firmware for implementing each of the aforementioned functions and components may be stored in a memory internal or external to the hazer and may be accessed by each controller for execution by the one or more processors of that controller. Alternatively, the functions and components of each controller may be implemented with hardware in that controller, or may be implemented using a combination of the aforementioned hardware and software/firmware. The controller may also be a component of, or include, a processing system, such as described below with respect to FIG. 8.

The controller 102 may also be configured to measure the output voltage 121 (e.g., from power supply adapter 122 or a battery) and to modify its instructions to maintain consistent power over different output voltages. For instance, when executing any of the aforementioned functions of the hazer or other described functions or processes, the controller may adjust the PWM percentage applied to pump control wires, air flow rate control wires, fan speed control wires, heater control wires, or other circuitry (see, e.g., FIG. 1) to protect the various hazer components and provide consistent hazer operation over the output voltage range. For example, the controller may apply a larger PWM percentage (e.g., larger voltage pulse widths) to any of such wires in response to an output voltage measurement of 12 V and a smaller PWM percentage (e.g., smaller voltage pulse widths) to any of such wires in response to an output voltage measurement of greater than 12 V, in order to maintain consistent power over the output voltage range of 12-15 V.

In one aspect, the hazer 100 may include peristaltic pump 110. The peristaltic pump may pump fluid 124 from a fluid tank 126 connected to the hazer. For example, a tube 128 (e.g., a silicone tube or other material) may be connected between the fluid tank and the peristaltic pump in the hazer, and the peristaltic pump may pump fluid through the tube via a stepper motor driving a rotor including rollers which pinch the tube and apply pressure to the fluid as the roller rotates. In one example, tube 128a may refer to the portion of tube 128 at the inlet of the peristaltic pump 110, and tube 128b may refer to the portion of tube 128 at the outlet of the peristaltic pump 110. In another example, tube 128a and tube 128b may be separate tubes attached to the peristaltic pump, and tube 128 may be another tube within the peristaltic pump which connects to and combines with tubes 128a and 128b to effectively form one tube. Thus, in either example, tube 128, tube 128a, and tube 128b may all refer to the same tube (e.g., a single or combined tube). The controller 102 may be configured to actuate the peristaltic pump to pump the fluid through the tube. For example, the controller may be coupled to the stepper motor in the peristaltic pump via a pump control wire (or other connection) such as illustrated in FIG. 1, and the controller may actuate the peristaltic pump (e.g., the stepper motor) by applying a voltage to the wire to cause the stepper motor to rotate the rotor in the pump and subsequently pump out the fluid. In various aspects, the fluid in the tube from the fluid tank may be water-based haze (e.g., propylene glycol) or sanitizing solution (e.g., triethylene glycol).

The controller 102 may monitor a fluid level 130 in the fluid tank 126 based on the peristaltic pump 110. For example, the peristaltic pump may provide precise fluid metering since the pump may output a same amount of fluid 124 every given number of steps (e.g., 1 milliliter or some other amount of fluid for every 28 partial revolutions or some other number of steps), and the controller may calculate an amount of fluid remaining in the fluid tank at any given time based on the total number of partial revolutions performed. For example, the controller may initialize a counter after the fluid tank is attached to the hazer, and the controller may increment the counter in response to each partial revolution in order to calculate the total amount of fluid which has been consumed in hazer and thus the fluid level in the fluid tank. If the controller determines the fluid level falls below a given Threshold (e.g., ½ L, 50% of the Fluid Tank Volume, or Some Other Value or percentage), the controller may output the fluid level, or an indication that the fluid tank will need (or currently needs) replacement, via display 116, via indicator(s) 118, or via DMX/RDM communication through DMX connector(s) 114. When a fluid tank is replaced, the controller may reset the counter for subsequent fluid level calculations. Moreover, since the fluid in the peristaltic pump is prevented from forward or reverse movement by the rollers (which thus serve a similar function to bidirectional check valves), fluid leaks may not occur from the tube if the fluid tank is removed for replacement or if the heater 112 is removed for replacement.

In another aspect, the hazer 100 may include air pump 108. The air pump may pump air through the tube 128b, which air may cause pressure that transports the pumped fluid (from peristaltic pump 110) through the tube towards the heater 112. The controller 102 may be configured to adjust the air flow rate of the air pump. For example, the controller may be coupled to the air pump via an air flow rate control wire (or some other connection) such as illustrated in FIG. 1, and the controller may adjust the air flow rate by applying PWM. For instance, the air pump may be powered by a DC motor which rotates at different speeds depending on an applied voltage pulse width, and the controller may select different air pump flow rates or speeds by applying different voltage pulse widths to the air flow rate control wire. The controller may thus select different air pump flow rates for different hazer functions, such as pre-heating, outputting haze 123, and cleaning. For example, the controller may select a slower flow rate to pump less air (and thus less fluid over time) through the tube during a warm up operation, and the controller may select a faster flow rate to pump more air through the tube (and thus more fluid over time) during a cleaning operation.

In another aspect, the hazer 100 may include pressure sensor 106. The pressure sensor may sense pressure in tube 128b, for example, in response to fluid 124 entering the tube from the peristaltic pump 110, or in response to carbon build-up from the fluid in the tube or heater 112. The pressure sensor may also be waterproof to maintain functionality upon contact with the fluid in the tube. The controller may be configured to monitor the pressure sensor for changes in pressure in the tube. For example, the controller may be coupled to the pressure sensor via a pressure sensor wire (or other connection) such as illustrated in FIG. 1, and the controller may receive information (e.g., sensed pressure) at any given time from the pressure sensor over the pressure sensor wire. If the controller determines that a slight change in pressure in the tube has occurred relative to a reference pressure, the controller may determine that fluid has entered the tube from the peristaltic pump.as well as the time that the fluid entered the tube. If the controller periodically determines this slight change in pressure to occur every given number of steps in the peristaltic pump over time, the controller may determine that the peristaltic pump successfully pumps a uniform amount of fluid periodically into the tube and heater. Otherwise, the controller may output that an error has occurred with the peristaltic pump, tube, or heater, or an indication that the peristaltic pump, tube, or heater needs replacement, via display 116, via indicator(s) 118, or via DMX/RDM communication through DMX connector(s) 114. Similarly, if the controller determines that a significant change in pressure in the tube has occurred relative to a reference pressure (e.g., a larger change in pressure than that caused due to fluid entry), the controller may determine that fluid is not adequately flowing through the tube due to a blockage (e.g., from carbon build-up or other factors), due to a low air flow rate, or due to other issues. As a result, the controller may output that an error has occurred with the air pump, tube or heater, or an indication that the air pump, tube or heater needs replacement, via display 116, via indicator(s) 118, or via DMX/RDM communication through DMX connector(s) 114. Additionally if the controller determines that the pressure in the tube is reading near zero, the controller may determine and output an indication of a faulty air pump or pressure sensor. Additionally, the controller 102 may be configured upon hazer power-up to auto-prime (auto-run) the peristaltic pump 110 based on monitored pressure from pressure sensor 106. For example, the controller may initially on power-up of hazer 100 actuate the peristaltic pump to rotate its rotor and move the fluid 124 until an amount of fluid enters the tube 128b resulting in a change in pressure sensed by the pressure sensor, in response to which the controller may cease actuating the peristaltic pump.

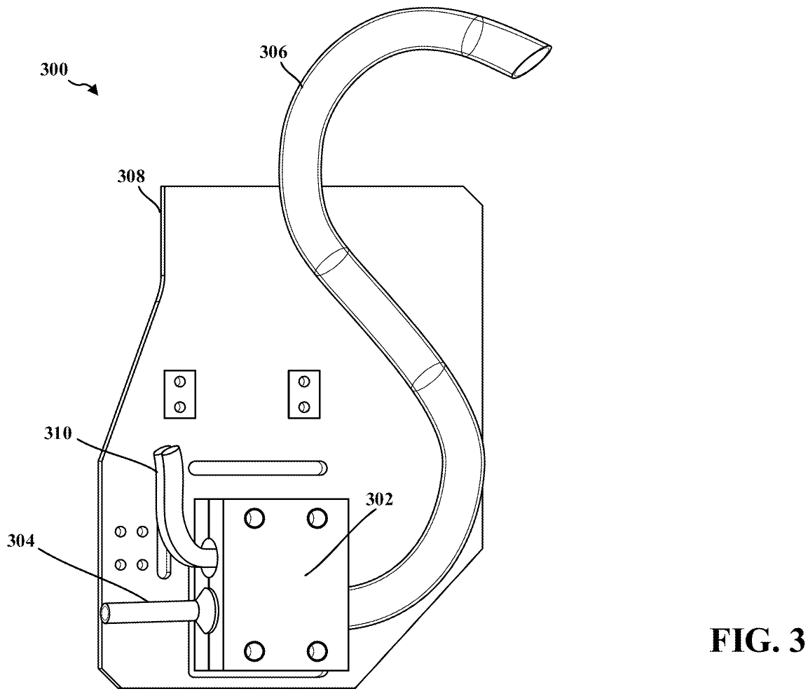

In another aspect, the hazer 100 may include heater 112. The heater may be configured to vaporize the pumped fluid entering the heater from tube 128b (in response to air flow from air pump 108) to form the haze 123. FIG. 3 illustrates an example 300 of heater 112. The heater may be a heater oven which includes and encloses a heater block 302 that contains tube 128b, a cartridge heater (not shown) inside the heater block that heats fluid 124 within the enclosed tube to a controller-configured temperature at which the fluid is converted at least partially into vapor (e.g., 215-220 degrees Celsius or higher temperature), an inlet 304 connected to the tube 128b that receives the fluid into the heater block, an outlet 306 through which heated fluid (vapor or haze 123) may escape from the heater block through hazer outlet 132, and a PCB 308 to which the heater block, inlet, and outlet are attached. The heater block 302 and outlet 306 may be of copper material, or some other material with relatively high thermal conductivity. On the other hand, the inlet 304 may be of stainless steel material, or some other material with less thermal conductivity than copper or the enclosure material, in order to conduct less heat at the junction between the tube 128b (e.g., of silicone material) and the heater. The PCB may be of polyamide, carbon fiber, or fiberglass material. Alternatively, the heater may not include the PCB 308, and instead the heater block 302 may be mounted on stainless steel posts within the heater (e.g., the heater oven case).

The outlet 306 may be contorted (e.g., in serpentine fashion such as illustrated in FIG. 3) in order to limit the escape of heated fluid that has not fully vaporized and exited through the hazer outlet 132. For example, when air flowing from air pump 108 carries fluid 124 through the inlet 304 into the enclosure 302 along with haze 123 from the enclosure through the contorted outlet, any fluid that has not fully vaporized into haze may collide with the sides of the contorted tube in response to the air flow and subsequently flow back into the enclosure, thereby minimizing the risk that hot liquid may escape from the hazer output. Additionally, in the event hot fluid happens to escape from the contorted tube, the hazer may include an output sponge 134 positioned inside or underneath the hazer outlet to catch the droplets that escape from the contorted tube.

The heater 112 may also include a thermocouple 136 that senses a temperature of the heater. The controller 102 may be configured to determine the temperature of the heater from the thermocouple. For example, the controller may be coupled to the thermocouple via a temperature sense wire (or other connection) such as illustrated in FIG. 1, and the controller may determine a temperature of the heater in response to a voltage applied on the temperature sense wire. If the controller determines the temperature exceeds an absolute thermal maximum (e.g., greater than 300 degrees Celsius or some other value), the controller may determine that the level of heat is unsafe and the controller may cease supplying power to the heater control wires to deactivate the cartridge heater. The controller may also perform open thermocouple detection (OTD). For example, the controller may determine that the thermocouple has an open circuit, and thus does not reliably sense temperature, in response to detecting a significantly large voltage applied on the temperature sense wire with respect to a reference voltage.

The controller 102 may be configured to cause the heater 112 to heat fluid 124 to form the haze 123. For example, the controller may be coupled to the heater via one or more heater control wires 310 (or other connection), such as illustrated in FIGS. 1 and 3, and the controller may cause the heater to vaporize the fluid by supplying power to the heater control wires, which activate the cartridge heater to heat the fluid to a configured temperature which results in haze. For example, the controller may apply power to the heater control wires to continue heating fluid until the controller determines that the fluid has heated to 215-220 degrees Celsius or other configured temperature (e.g., based on readings from the thermocouple), after which the controller may cease applying power to the heater control wires to maintain the configured temperature. Moreover, in contrast to conventional hazers, which tend to include high power heaters (e.g., 375 W, 750 W, or even 1000-1100 W power output), this heater may be a micro-heater with low power to enable servicing or replacement of heater components (e.g., an average of 35 W power output with a maximum power output of 60 W). Thus, in the event a problem with the heater arises, the user may safely remove or replace the heater or heater components with minimal risk of injury.

The controller 102 may also be configured to clean the hazer (e.g., hazer 100, 402, 404). For example, the controller may perform a self-cleaning cycle on power-up, during which time the controller may at least adjust the air pump 108 with a high air flow rate to rapidly move fluid through the tube 128b into the heater 112 and cause the heater to heat the fluid entering the enclosure 302 up to a configured cleaning temperature (e.g., 293 degrees Celsius or some other temperature) in order to boil any fluid in the enclosure 302 and remove remaining fluid from the hazer. Moreover, during operation of the hazer (after power-up), the controller may run one or more cleaning cycles based on monitored fluid usage or an elapsed time since power-up. For example, the controller may perform a self-cleaning cycle if the controller determines the fluid level 130 of fluid tank 126 to have reduced by a certain amount of fluid (e.g., each time the fluid level has reduced by 1/10 L, 10% of the fluid tank capacity, or some other value or percentage). This value or percentage may be calculated, for example, based on the number of revolutions that have occurred in the peristaltic pump 110. Additionally, the controller may perform additional self-cleaning cycles in response to determining that the fluid level has reach different values or percentages (e.g., ¼ L, 25% of fluid tank, etc.). In another example, the controller may perform a self-cleaning cycle in response to determining that an amount of time which has elapsed since hazer power-up exceeds a threshold (e.g., a number of minutes, hours, etc.). The threshold may also be based on a current haze output level. For example, the controller may perform a self-cleaning cycle every time the hazer has started (powered-up), every 4 hours at 100% haze output, or every 6 hours at 75% haze output. The controller may similarly perform additional self-cleaning cycles in response to determining that the elapsed time exceeds other thresholds (e.g., a different number of minutes, hours, etc.).

In another aspect, the hazer 100 may include fan 104 which circulates air into the hazer and which carries haze 123 from outlet 306 through hazer outlet 132. The air may enter the fan from outside the hazer through a hazer inlet 139. The fan 104 may be coupled to the hazer, for example, via spring contacts (e.g., without wire or cable). The fan may include an air filter 137 that may capture dust in circulated air. The fan may also include a tachometer 138 which measures a current speed of the fan. Additionally, the fan may include a fan sponge 140 positioned underneath the fan to catch condensed fluid droplets or haze 123 captured by the fan and re-circulated into the hazer through the hazer inlet. Alternatively in other aspects, the hazer may not include fan 104, and the hazer may instead be connected to an HVAC system which blows air through the hazer. This aspect relating to the HVAC system is described in more detail below with respect to FIGS. 5A and 5B.

The controller 102 may be configured to control a speed of the fan 104. For example, the controller may be coupled to the fan via a fan speed control wire (or other connection), such as illustrated in FIG. 1, and the controller may set the fan speed by applying PWM. For instance, the fan may be powered by a DC motor which rotates at different speeds depending on an applied voltage pulse width, and the controller may select different fan speeds by applying different voltage pulse widths to the fan speed control wire. The controller may also be configured to obtain tachometer measurements. For example, the controller may be coupled to the tachometer 138 via a tach measurement wire (or other connection), such as illustrated in FIG. 1, and the controller may determine a measured fan speed based on the frequency of a signal received on the wire. Based on the set fan speed and the tachometer measurement, the controller may determine whether the fan is running correctly or if an error has occurred. For example, if the controller determines that the measured fan speed obtained from the tachometer is less than the set fan speed (e.g., due to accumulated dust and fluid condensation/haze 123 in the fan), the controller may output that an error has occurred with the fan or an indication that the fan needs to be cleaned or replaced, via display 116, via indicator(s) 118, or via DMX/RDM communication through DMX connector(s) 114. For instance, the controller may output an error if the fan speed was set to run at 35% but the tachometer indicated the actual fan speed was running at only 30%. In another example, if the controller determines that the measured fan speed is less than a minimum fan speed for hazer operation (e.g., 25% speed or some other value), the controller may cease supplying power to the hazer components and shut down the hazer.

In another aspect, the hazer may include inputs 120 (e.g., buttons or any other type of input) allowing the user to select hazer parameters, and the controller 102 may be coupled to the inputs via an input wire (or other connection, wired or wireless) such as illustrated in FIG. 1. For example, the hazer may include one or more buttons with which a user may select to power on/off the hazer, select a mode of operation (e.g., haze output, warm-up, cleaning, auto-prime, etc.), select a level of haze output (e.g., a value between 0 and 255 or a percentage between 0 and 100%), select a fan speed (e.g., a value between 0 and 255 or a percentage between 0 and 100%), select one of multiple DMX settings (in some aspects, although the DMX setting may be automatically configured in other aspects), or select other parameters. In another aspect, the hazer may include an output display 116 (e.g., a liquid crystal display (LCD) or other display) for displaying input parameters, errors, or other information, and the controller may be coupled to the output display via an output wire (or other connection, wired or wireless) such as illustrated in FIG. 1. For example, the hazer may include a two-line, 32-character LCD display on which the controller may output a selected mode of operation, haze output level, fan speed, DMX setting, error report, or other parameters. Alternatively, the inputs 120 and output display 116 may be combined into a single component, such as a touch screen display, and the controller may receivedata from and outputdata to the touch screen display. The controller may receive the data from the inputs (or combined display and input) via the input wire or other connection, or from an external controller via a DMX connector, and the controller may configure one or more hazer components based on the received data accordingly. For example, the controller may adjust the air flow rate of the air pump, e.g., using different voltage pulse-widths corresponding to the received value or percentage of haze output, or control the speed of the fan, e.g., using different voltage pulse-widths corresponding to the received value or percentage of fan speed.

In another aspect, the hazer may include indicator(s) 118 respectively indicating statuses of hazer components (e.g., light-emitting diodes (LEDs), alarms or sounds, or other indicators such as illustrated in FIG. 2B), and the controller may be coupled to the indicator(s) via one or more wires or other connections. The controller may output data to the indicators, such as error reports, alternatively to or additionally with the output display. For example, an indicator may each be associated with the heater, fan, air pump, and peristaltic pump, and the controller may light a corresponding indicator, change a color of the indicator, play a sound, etc. if the controller determines an error has occurred with the respective component such as described above.

In another aspect, the hazer 100 may include DMX connectors 114 configured for DMX communication with other devices. DMX connectors may be, for example, 8-pin RJ-45 connectors or ports. The hazer may receive and send data via DMX connectors 114 over a DMX interface, such as an RS-485 bus. For instance, the hazer may communicate over the RS-485 bus with an external controller (e.g., in a lighting control console, personal computer, etc.), or with other hazers (e.g., master or slave hazers). If the hazer is a master hazer, one DMX connector may be connected to the external controller, while another DMX connector may be connected to a slave hazer. If the hazer is a slave hazer, one DMX connector may be connected to the master hazer, and another DMX connector may be terminated, connected to another slave hazer, or connected to another DMX device.

FIG. 4 illustrates an example of a system 400 including multiple hazers in a master-slave arrangement, where each of the hazers corresponds to hazer 100 of FIG. 1. For example, the hazers may include a master hazer 402 and one or more slave hazers 404 coupled together in daisy-chain fashion, such as illustrated in FIG. 4. A controller 406 external to the hazers (e.g., a controller in a lighting control console, personal computer, etc.) is coupled to each of the hazers (directly or indirectly) via DMX interfaces 408, and the controller 406 may be configured to transmit to and receive data from the hazers over the DMX interface. For example, if the controller 406 transmits data to the internal controller (e.g., controller 102) of the master hazer over the DMX interface, the controller of the master hazer may transmit duplicate or similar data to the internal controller (e.g., controller 102) of the next slave hazer over the DMX interface, which controller in turn may transmit duplicate or similar data to the internal controller (e.g., controller 102) of the following slave hazer over the DMX interface, and so forth. The controller 406 may receive data similarly from the internal controller of the master hazer and slave hazers over the DMX interface.

Such master-slave arrangement allows the external controller to efficiently send a single message to the master hazertocontrol operation of master and slave hazers, to provide firmware upgrades to the controllers of master and slave hazers, and the like. For example, if controller 406 receives a selected haze output or fan speed from a user at the lighting control console, personal computer, etc., the controller 406 may communicate this data to any of the hazers in the system 400 over the DMX interface, and the controllers 102 in each hazer may adjust their respective air flow rate, fan speed, etc. to control haze output from the hazers accordingly. Similarly, controller 406 may receive error reports from each hazer over the DMX interface. Additionally, such master-slave arrangement allows the internal controller of the master hazer to efficiently send a single message to the slave hazers to control operation of slave hazers. For example, if the controller 102 of the master hazer receives a selected haze output or fan speed from a user via inputs 120, the controller 102 may similarly communicate this data to the slave hazers in the system 400 over the DMX interface.

In various aspects, a hazer (e.g., hazer 100, 402, 404) may operate under different DMX settings. Examples of DMX settings may include a stand-alone mode in which a hazer operates in response to user selected inputs via inputs 120 (e.g., controlled by controller 102), or a DMX mode in which a hazer operates in response to inputs provided via DMX connector(s) 114 (e.g., controlled by controller 406). In one aspect, the controller 102, 406 may receive the DMX setting for a hazermanually from the user (e.g., via inputs 120). In another aspect, the DMX setting may not be manually selected by the user, but configured automatically. For instance, the controller 102, 406 may switch a DMX setting of a hazer to DMX mode if the controller determines data is received/transmitted via DMX connector(s) 114, without requiring the user to select that mode manually via inputs 120.

In one aspect, when the hazer (e.g., hazer 100, 402, 404) is running in a stand-alone mode, the hazer may operate in a continuous mode, or in a timer mode. In the continuous mode, the controller 102 may constantly supply power to the various hazer components in order to continually pump fluid 124 from fluid tank 126 into the tube 128 and heater 112 to form haze 123. While in the continuous, stand-alone mode, the controller may enable selected haze outputs for hazing small areas. For example, the controller may receive a selected haze output between 0 and 9% from inputs 120 or DMX connector(s) 114, or other values or percentages corresponding to slow haze output for hazing small areas, and the controller may adjust the air flow rate of the air pump 108 accordingly while operating in the continuous mode. While in the timer mode, the controller may initialize a timer and operate based on a selected haze output until the timer has expired. Once the timer expires, the controller may cease supplying power to one or more of the various hazer components to stop or shut-down hazer operation.

In a further aspect, the controller 102, 406 may be configured to receive or transmit data over different DMX channels 410, and each DMX channel may correspond to a different hazer function or hazer mode. For instance, one DMX channel may be configured to correspond to haze output and another DMX channel may be configured to correspond to fan speed. As a result, when the controller 102 of a hazer (e.g., hazer 100, 402, 404) receives data in a given DMX channel, the controller may control a corresponding hazer component in response to the received data in that channel. For example, if the controller 102 of that hazer receives a value or percentage in one DMX channel via inputs 120 or DMX connector 114 that corresponds to haze output, the controller may adjust air flow rate of that hazer based on the received value or percentage accordingly such as described above. Similarly, if the controller 102 of that hazer receives a value or percentage in another DMX channel via inputs 120 or DMX connector 114 that corresponds to fan speed, the controller may set the fan speed of that hazer based on the received value or percentage accordingly such as described above.

In one aspect, the DMX channels 410 may be configured to correspond to different hazer functions or modes (e.g., one DMX channel configured for hazer output, another DMX channel configured for fan speed, etc.), such as described above. However in a different aspect, a first DMX channel 412 may be configured to correspond to the hazer mode (e.g., haze output or fan speed), and a second DMX channel 414 may be configured to correspond to data (e.g., a specified value or percentage). As a result, when the controller 102 of a hazer (e.g., hazer 100, 402, 404) receives data in the first DMX channel, the controller may determine a hazer component in response to the received data, and when the controller subsequently receives data in the second DMX channel, the controller may control the determined hazer component in response to the received data in that channel. For example, if the controller 102 of a hazer receives the value 0 (or some other number) corresponding to haze output in the first DMX channel, the controller may adjust air flow rate of that hazer based on the received value or percentage in the second DMX channel. On the other hand, if the controller of the hazer receives the value 1 (or some different number) corresponding to fan speed in the first DMX channel, the controller may adjust fan speed of that hazer based on the received value or percentage in the second DMX channel.

In another aspect, the hazer (e.g., hazer 100, 402, 404) may include a tool holder 142 which may be configured to contain a tool 144 (e.g., a T20 Torx® tool or some other brand or type of tool) for servicing the hazer. For example, as illustrated in FIG. 2A, the tool holder 142 may be a recess or cavity in the hazer, in which tool 144 may be inserted for convenient storage and removed for use in servicing the various components of the hazer. In a further aspect, the various components of the hazer may be modular and allow in-field replacement. For instance, the peristaltic pump 110, air pump 108, fan 104, and heater 112 may be affixed to pre-fabricated sections or areas of the hazer using screws or other fasteners, which fasteners can be attached or removed to the hazer using the same tool in tool holder 142. For example, the screws affixing each component of the hazer may all include the same screw head compatible with the tool 144. In this way, users may be able to use the tool 144 accompanying the hazer (in tool holder 142) to easily and conveniently remove and replace the various components of the hazer.

In one aspect, a caddy (not shown) may be attached to the hazer (e.g., hazer 100, 402, 404) for holding accessories to the hazer, such as the fluid tank 126 and power supply adapter 122 (or battery). The caddy allows a user to transport the hazer and its accessories at one time, facilitating placement of the hazer within a venue or moving the hazer from one venue to another. Moreover, the hazer with attached caddy may be of a small or compact size capable of fitting within a vehicle trunk, further facilitating its transportation capabilities. The caddy may also be detachable from the hazer.

Referring to FIGS. 5A-5B, in an additional aspect, the hazer (e.g., hazer 100, 402, 404) may be attached (e.g., with bolts or other fastener) to an air duct 500 in an HVAC system. For example, one or more stand-alone hazers such as hazer 100 or one or more master-slave hazers such as in system 400 may be attached to air duct(s) in an HVAC system (e.g., system 400 may include air duct 500). Thus, since the HVAC system itself supplies the air to the hazer, the hazer may not include fan 104 in this aspect. For instance, as illustrated in the example of FIGS. 5A-5B, hazer 502 may include an air inlet 504 attached to air duct 500 which receives air flowing through the air duct, and a haze outlet 506 through which haze 123 flows out of the hazer. For example, the air inlet may be a scoop or other structure attached to hazer inlet 139 which captures air flowing through the air duct, and the haze outlet may be another scoop or other structure attached to hazer outlet 132 which allows haze 123 to exit the hazer. In some aspects, such as illustrated in FIG. 5B, the haze outlet may also be attached to the air duct to circulate haze through the HVAC system. Thus, haze may be easily circulated through air ducts within a venue.

The hazer 502 may include a vane switch (not shown) which triggers in response to the flow of air through the air inlet 504 (e.g., based on displacement of a paddle in the switch or some other manner). Moreover, the controller 102 may be configured to actuate the peristaltic pump 110 to pump fluid 124 into heater 112 in response to the triggering of the vane switch. In this way, the hazer may power-efficiently operate only when air is flowing through the HVAC system. For example, the controller may be coupled to the vane switch via a flow switch wire or other connection. When the paddle in the vane switch displaces as a result of air flow through air inlet 504, the controller may receive a signal from the vane switch over the flow switch wire. In response to receiving this signal, the controller may apply voltage to the pump control wire to rotate the rotor in the peristaltic pump 110 and pump out fluid through tube 128b into the heater. Alternatively, the peristaltic pump may be directly coupled to the vane switch and triggered to pump fluid in response to air flow through the vane switch.

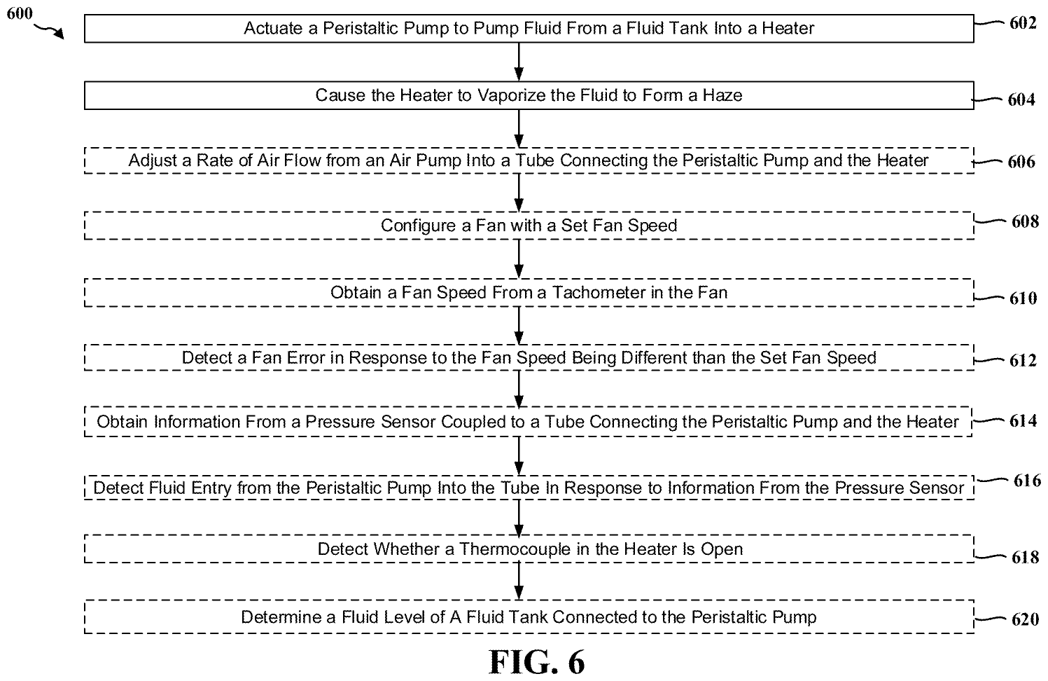

FIG. 6 illustrates an example flow chart of a method 600 for controlling operation of a hazer (e.g., hazer 100, 402, 404, 502). For example, the method can be carried out in a controller such as the one illustrated in FIG. 1 or 4 (e.g., controller 102 or controller 406). Each of the steps in the flow chart can be controlled using the controller as described below (e.g. controller 102, 406), by a component or module of the controller, or by some other suitable means. Optional aspects are illustrated in dashed lines.

As represented by block 602, the controller 102, 406 may actuate a peristaltic pump to pump fluid from a fluid tank into a heater. For instance, referring to the aforementioned Figures, the controller 102, 406 may actuate the peristaltic pump 110 to pump the fluid 124 through the tube 128. For example, the controller 102 may be coupled to the stepper motor in the peristaltic pump via a pump control wire (or other connection) such as illustrated in FIG. 1, and the controller 102 may actuate the peristaltic pump (e.g., the stepper motor) by applying a voltage to the wire to cause the stepper motor to rotate the rotor in the pump and subsequently pump out the fluid from fluid tank 126 into heater 112. Similarly, the controller 406 may actuate the peristaltic pump, for example, by providing a message or instruction to controller 102 (e.g., via DMX) to rotate the rotor.

As represented by block 604, the controller 102, 406 may cause the heater to vaporize the fluid to form a haze. For instance, referring to the aforementioned Figures, the controller 102 may cause the heater 112 to heat fluid 124 to form the haze 123. For example, the controller may be coupled to the heater via one or more heater control wires 310 (or other connection), such as illustrated in FIGS. 1 and 3, and the controller may cause the heater to vaporize the fluid by supplying power to the heater control wires, which activate the cartridge heater to heat the fluid to a configured temperature which results in haze. For example, the controller may apply power to the heater control wires to continue heating fluid until the controller determines that the fluid has heated to 215-220 degrees Celsius or other configured temperature (e.g., based on readings from the thermocouple), after which the controller may cease applying power to the heater control wires to maintain the configured temperature. Similarly, the controller 406 may cause the heater to vaporize the fluid, for example, by providing a message or instruction to controller 102 (e.g., via DMX) to apply power to the heater control wires.

As represented by block 606, the controller 102, 406 may adjust a rate of air flow from an air pump into a tube connecting the peristaltic pump and the heater. For instance, referring to the aforementioned Figures, the controller 102 may adjust the rate of air flow from the air pump 108 into tube 128b connecting peristaltic pump 110 and heater 112. For example, the controller may be coupled to the air pump via an air flow rate control wire (or some other connection) such as illustrated in FIG. 1, and the controller may adjust the air flow rate by applying PWM. For instance, the air pump may be powered by a DC motor which rotates at different speeds depending on an applied voltage pulse width, and the controller may select different air pump flow rates or speeds by applying different voltage pulse widths to the air flow rate control wire. Similarly, the controller 406 may adjust the rate of air flow from the air pump, for example, by providing a message or instruction to controller 102 (e.g., via DMX) to apply PWM to the flow rate control wire.

As represented by block 608, the controller 102, 406 may configure a fan with a set fan speed. Moreover, as represented by block 610, the controller 102, 406 may obtain a fan speed from a tachometer in the fan, and as represented by block 612, the controller 102, 406 may detect a fan error in response to the fan speed being different than the set fan speed. For instance, referring to the aforementioned Figures, the controller 102 may control a speed of the fan 104. For example, the controller may be coupled to the fan via a fan speed control wire (or other connection), such as illustrated in FIG. 1, and the controller may set the fan speed by applying PWM. For instance, the fan may be powered by a DC motor which rotates at different speeds depending on an applied voltage pulse width, and the controller may select different fan speeds by applying different voltage pulse widths to the fan speed control wire. The controller 102 may also obtain tachometer measurements from the fan 104. For example, the controller 102 may be coupled to the tachometer 138 via a tach measurement wire (or other connection), such as illustrated in FIG. 1, and the controller may determine a measured fan speed based on the frequency of a signal received on the wire. Based on the set fan speed and the measured fan speed, the controller 102 may determine whether the fan is running correctly or if an error has occurred. For example, if the controller 102 determines that the measured fan speed obtained from the tachometer is less than the set fan speed (e.g., due to accumulated dust and fluid condensation/haze 123 in the fan), the controller may output that an error has occurred with the fan or an indication that the fan needs to be cleaned or replaced, via display 116, via indicator(s) 118, or via DMX/RDM communication through DMX connector(s) 114. In another example, if the controller 102 determines that the measured fan speed is less than a minimum fan speed for hazer operation (e.g., 25% speed or some other value), the controller may cease supplying power to the hazer components and shut down the hazer. Similarly, the controller 406 may control the fan speed and detect fan errors, for example, by providing a message or instruction to controller 102 (e.g., via DMX) to apply PWM to the fan speed control wire to set a fan speed and transmit a tach measurement from the fan back to the controller 406 to identify a measured fan speed (or alternatively transmit the measured fan speed to the controller 406), and by determining whether the measured fan speed is different than the set fan speed.

As represented by block 614, the controller 102, 406 may obtain information from a pressure sensor coupled to a tube connecting the peristaltic pump and the heater, and as represented by block 616, the controller 102, 406 may detect fluid entry from the peristaltic pump into the tube in response to information from the pressure sensor. For instance, referring the aforementioned Figures, the controller 102 may monitor the pressure sensor 106 for changes in pressure in the tube 128b. For example, the controller 102 may be coupled to the pressure sensor 106 via a pressure sensor wire (or other connection) such as illustrated in FIG. 1, and the controller may receive information (e.g., sensed pressure) at any given time from the pressure sensor over the pressure sensor wire. If the controller 102 determines that a slight change in pressure in the tube 128b has occurred relative to a reference pressure, the controller may determine that fluid 124 has entered the tube from the peristaltic pump 110, as well as the time that the fluid entered the tube. If the controller 102 periodically determines this slight change in pressure to occur every given number of steps in the peristaltic pump over time, the controller may determine that the peristaltic pump successfully pumps a uniform amount of fluid periodically into the tube and heater 112. Similarly, the controller 406 may obtain information from the pressure sensor and detect fluid entry from the peristaltic pump into the tube, for example, by providing a message or instruction to controller 102 (e.g., via DMX) to obtain and provide controller 406 a sensed pressure from pressure sensor 106, and by determining that fluid has entered the tube based on identification of a slight or periodic change in pressure in the tube 128b.

As represented by block 618, the controller 102, 406 may detect whether a thermocouple in the heater is open. For instance, referring to the aforementioned Figures, the controller 102 may perform OTD for thermocouple 136 in heater 112. For example, the controller 102 may be coupled to the thermocouple via a temperature sense wire (or other connection) such as illustrated in FIG. 1, and the controller may determine that the thermocouple has an open circuit and thus does not reliably sense temperature in response to detecting a significantly large voltage applied on the temperature sense wire with respect to a reference voltage. Similarly, the controller 406 may detect whether the thermocouple is open, for example, by providing a message or instruction to controller 102 (e.g., via DMX) to transmit an indication to controller 406 that the thermocouple is open based on the temperature sense wire voltage (or to transmit an indication of such voltage to controller 406 to perform OTD).

Finally, as represented by block 620, the controller 102, 406 may determine a fluid level of a fluid tank connected to the peristaltic pump. For instance, referring to the aforementioned Figures, the controller 102 may monitor the fluid level 130 in fluid tank 126 based on the fluid metering provided by the peristaltic pump 110. For example, the peristaltic pump 110 may output a same amount of fluid every given number of steps or partial revolutions of the rotor in the peristaltic pump, and the controller 102 may calculate an amount of fluid remaining in the fluid tank 126 at any given time based on the total number of steps or partial revolutions which have been performed in the peristaltic pump. As an example, the controller 102 may initialize a counter after the fluid tank 126 is attached to the hazer 100, 402, 404, 502 and the controller may increment the counter in response to each partial revolution of the peristaltic pump 110 in order to calculate the total amount of fluid which has been consumed in the hazer and thus the fluid level 130 remaining in the fluid tank. Similarly, the controller 406 may determine the fluid level, for example, by providing a message or instruction to controller 102 (e.g., via DMX) to provide controller 406 the calculated fluid level or the total number of steps performed for controller 406 to calculate the fluid level 130.

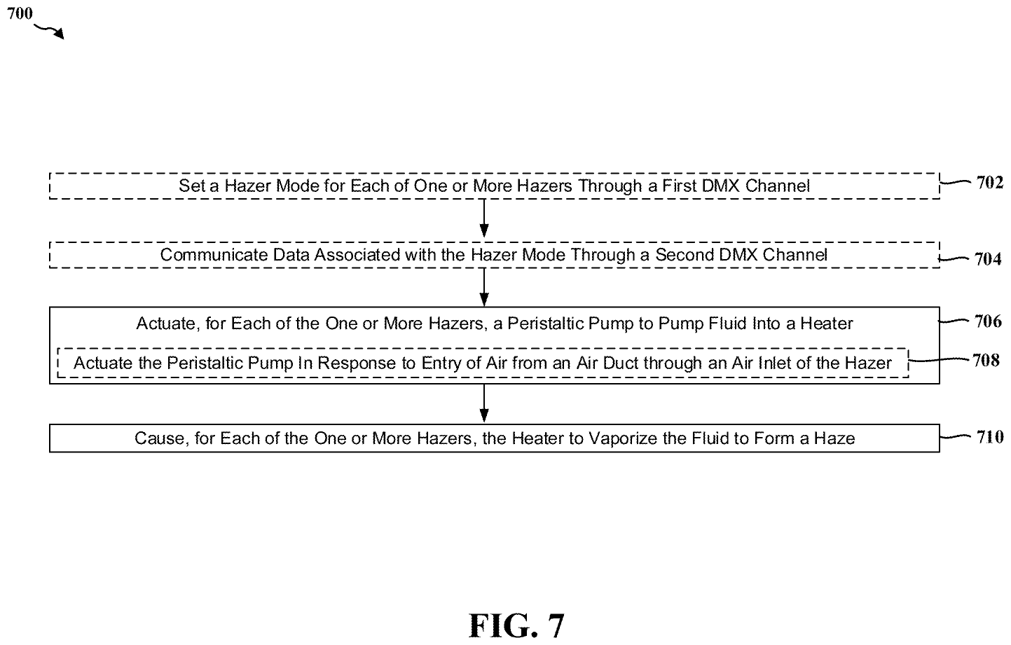

FIG. 7 illustrates an example flow chart of a method 700 for controlling operation of a hazer (e.g., hazer 100, 402, 404, 502). For example, the method can be carried out in a controller such as the one illustrated in FIG. 1 or 4 (e.g., controller 102 or controller 406). Each of the steps in the flow chart can be controlled using the controller as described below (e.g. controller 102, 406), by a component or module of the controller, or by some other suitable means. Optional aspects are illustrated in dashed lines.

As represented by block 702, the controller 102, 406 may set a hazer mode for each of one or more hazers through a first DMX channel, and as represented by block 704, the controller 102, 406 may communicate data associated with the hazer mode through a second DMX channel. For instance, referring the aforementioned Figures, each hazer 100, 402, 404, 502 may include multiple DMX channels 410, where a first DMX channel 412 is configured to correspond to a hazer mode (e.g., haze output or fan speed), and a second DMX channel 414 is configured to correspond to data (e.g., a specified value or percentage corresponding the hazer output level or fan speed). In such case, controller 102, 406 may set a hazer mode for a hazer by transmitting to that hazer over the first DMX channel an indicator of the hazer component to be controlled (e.g., air pump for haze output, fan for fan speed), and the controller 102, 406 may communicate data associated with this hazer mode by transmitting to that hazer over the second DMX channel a specified value or percentage of the amount of control (e.g., haze output level, fan speed). As an example, controller 102, 406 may provide to a master or slave hazer one value indicating a haze output mode over the first DMX channel of that hazer and a haze output level within range 0-255 or 0-100% over the second DMX channel of that hazer. In response to this information, the controller receiving the values over the DMX channels may adjust its air flow rate accordingly for different haze output levels. Alternatively, controller 102, 406 may provide to the master or slave hazer another value indicating a fan speed mode over the first DMX channel of that hazer and a fan speed within range 0-255 or 0-100% over the second DMX channel of that hazer. In response to this information, the controller receiving the values over the DMX channels may adjust its fan speed according to the set value or percentage.

As represented by block 706, the controller 102, 406 may, for each of the one or more hazers, actuate a peristaltic pump to pump fluid from a fluid tank into a heater. For instance, referring to the aforementioned Figures, the controller 406 may actuate the peristaltic pump in master hazer 402 to pump fluid 124 through its tube, e.g., as described above at block 602 of FIG. 6 (for example, via a message or instruction from controller 406 to controller 102 in the master hazer). Additionally, in response to receiving the message or instruction from the controller 406, the controller 102 in master hazer 402 may further actuate the peristaltic pump in one of the slave hazers 404 to also pump fluid, e.g., as described above at block 602 of FIG. 6 (for example, via a message or instruction from controller 102 in the master hazer to controller 102 in the slave hazer). Alternatively, controller 102 in master hazer 402 may actuate the peristaltic pump in the slave hazer (as well as its own pump) in response to user input (e.g., via inputs 120 or display 116). Furthermore, in response to receiving this message or instruction from the master hazer, the controller 102 in the slave hazer may further actuate the peristaltic pump in the next slave hazer as described above, and the slave hazers may continue in such manner until all hazers in the system 400 have been actuated.

Furthermore, as represented by block 708, the controller 102, 406 may, for each of the one or more hazers, actuate the peristaltic pump (at block 706) in response to entry of air from an air duct through an air inlet of the corresponding hazer. For instance, referring to the aforementioned Figures, one or more of the hazers 402, 404 may each correspond to hazer 502, which may include a vane switch that triggers in response to the flow of air through air inlet 504. In this aspect, the controller 102, 406 may actuate the peristaltic pump 110 of the hazer(s) 502 to pump fluid 124 into heater 112 (e.g., as described above at block 706) in response to the triggering of the vane switch for those hazer(s). For example, the controller of a hazer may be coupled to the vane switch via a flow switch wire or other connection. When a paddle in the vane switch displaces as a result of air flow through air inlet 504, the controller of that hazer may receive a signal from the vane switch over the flow switch wire. In response to receiving this signal, the controller of that hazer may actuate the hazer (e.g., the master hazer or slave hazer(s)) as described above at block 706.

Finally, as represented by block 710, the controller 102, 406 may cause, for each of the one or more hazers, the heater to vaporize the fluid to form a haze. For instance, referring to the aforementioned Figures, the controller 406 may activate the cartridge heater in master hazer 402 to heat fluid 124 to a configured temperature which results in haze, e.g., as described above at block 604 of FIG. 6 (for example, via a message or instruction from controller 406 to controller 102 in the master hazer). Additionally, in response to receiving the message or instruction from the controller 406, the controller 102 in master hazer 402 may further activate the cartridge heater in one of the slave hazers 404 to also heat fluid to the configured temperature, e.g., as described above at block 604 of FIG. 6 (for example, via a message or instruction from controller 102 in the master hazer to controller 102 in the slave hazer). Alternatively, controller 102 in master hazer 402 may activate the cartridge heater in the slave hazer (as well as its own heater) in response to user input (e.g., via inputs 120 or display 116). Furthermore, in response to receiving this message or instruction from the master hazer, the controller 102 in the slave hazer may further activate the cartridge heater in the next slave hazer as described above, and the slave hazers may continue in such manner until all hazers in the system 400 have been activated.

FIG. 8 illustrates an example of a processing system 800 for a hazer according to various aspects of the present disclosure (e.g., hazer 100, 402, 404). The processing system may include various types of machine-readable media and interfaces. For instance, as illustrated, the processing system may include at least one interconnect 802 (e.g., a bus), a permanent storage device 804, random-access memory (RAM) 806, at least one controller interface 808, read-only memory (ROM) 810, and at least one processor 812. In one aspect, the processing system may include controller 102 or controller 406. For example, controller 102 or controller 406 may correspond to processor(s) 812 of FIG. 8. Alternatively, the processing system may be a component of controller 102 or controller 406. For example, controller 102, 406 may include the processor(s), RAM, ROM, or other components of processing system 800.

The interconnect 802 may communicatively connect components and/or devices that are collocated with the processing system 800, such as internal components and/or internal devices within a housing of the hazer 100, 402, 404 or controller 102, 406. For example, the interconnect 802 may communicatively connect the processor(s) 812 with the permanent storage device 804, RAM 806, and/or ROM 810. The interconnect may also connect the processor(s) 812, RAM 806, and/or ROM 810 with various components of the hazer (e.g., via controller interface(s) 808). The processor(s) may be configured to access and load computer-executable instructions from at least one of the permanent storage device, RAM, and/or ROM.

The permanent storage device 804 may be non-volatile memory that stores instructions and data, independent of the power state (e.g., on or off) of the processing system 800. For example, the permanent storage device may be a hard disk, flash drive, or another read/write memory device.

ROM 810 may store static instructions enabling basic functionality of the processing system 800, as well as the components therein. For example, the ROM may store instructions for the processor(s) 812 to execute a set of processes associated with the hazer 100, 402, 404, for example, instructions to perform any of the various hazer operations described above in the various aspects of the present disclosure. Examples of ROM 810 may include erasable programmable ROM (EPROM) or electrically EPROM (EEPROM), compact disc ROM (CD-ROM) or other optical disk storage, magnetic disk storage or other magnetic storage devices, and/or another computer-accessible and computer-readable media that may store program code as instructions and/or data structures. In addition, ROM 810 may store data which the processor(s) transmits to, or receives from, the hazer 100, 402, 404 or its components.

RAM 806 may include volatile read/write memory. The RAM may store computer-executable instructions associated with runtime operation(s) by the processor(s) 812. In addition, RAM 806 may store data which the processor(s) transmits to, or receives from, the hazer 100, 402, 404 or its components.

The processor(s) 812 may be implemented with one or more general-purpose and/or special-purpose processors. Examples of general-purpose and/or special-purpose processors may include microprocessors, microcontrollers, DSP processors, and/or any other suitable circuitry configured to execute instructions loaded from at least one of the permanent storage device 804, RAM 806, and/or ROM 810. Alternatively or additionally, the processor(s) 812 may be implemented as dedicated hardware, such as at least one FPGA, at least one PLD, at least one controller, at least one state machine, a set of logic gates, at least one discrete hardware component, or any other suitable circuitry and/or combination thereof.

The interconnect 802 may further communicatively connect the processing system 800 with one or more controller interface(s) 808. The controller interface(s) may communicatively connect the processing system with a hazer (e.g., hazer 100, 402, 404) or various circuitry associated with one or more components of the hazer, for example, during hazer operation. Instructions executed by the processor(s) 812 may cause instructions to be communicated with the hazer or its components through the controller interface(s), which may cause the peristaltic pump 110 to actuate and pump fluid 124 through the tube 128, the heater 112 to vaporize the fluid into haze 123, and other components of the hazer to act during hazer operation such as described above. For example, instructions executed by the processor(s) 812 may cause signals to be sent through the controller interface(s) 808 to a hazer (e.g., via DMX), or to circuitry, components and/or machinery of a hazer (e.g., via pump control wires, heater control wires, etc.), as well as data to be received through the controller interface(s) 808 from the hazer or its circuitry, components, and/or machinery, in order to operate the hazer according to any of the various aspects previously described.

Various aspects described herein may be implemented at least partially as software processes of a computer-programming product. Such processes may be specified as a set of instructions recorded on a machine-readable storage medium. When a set of instructions is executed by the processor(s) 812, the set of instructions may cause the processor(s) to perform operations indicated and recorded in the set of instructions.

Accordingly, the hazer according to various aspects of the present disclosure may improve upon conventional hazers in many ways. For example, the hazer (e.g., hazer 100, 402, 404, 502) may include a peristaltic pump which provides more consistent operation and less failure rates than piston pumps, an air pump with variable, PWM air-flow adjustment, a fan with tachometer that allows for fan speed monitoring and error determination, RDM capabilities for error reporting over DMX, low voltages for safe and easy servicing or replacement of hazer components, a fan sponge for catching condensed fluid built up in a fan due to re-circulated haze, a pressure sensor which allows the controller to determine whether the peristaltic pump is pumping consistently and properly or whether a plugged tube exists, a heater which provides open thermocouple detection to allow the controller to determine whether a heater failure has occurred, or an air inlet and haze outlet that allow for connection of the hazer to an HVAC system. Moreover, in various aspects, the hazer maybe implemented in any of various commercial settings, e.g., in laser mazes, laser tag arenas, studios, nightclubs, theaters (lighting control) or other amusement settings, DJ/music settings, etc., using water-based haze for the fluid. Additionally, in other aspects, the hazer may be implemented in industrial applications, e.g., for sanitization (using triethylene glycol or other sanitizing solution).

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other hazing devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) in the United States, or an analogous statute or rule of law in another jurisdiction, unless the element is expressly recited using the phrase “means for” or, in the case of a method claim, the element is recited using the phrase “step for.”

What is claimed is:

1. A hazer comprising:
a peristaltic pump;
a heater; and
a controller coupled to the peristaltic pump and to the heater;
wherein the controller is configured to actuate the peristaltic pump to pump fluid into the heater, and to cause the heater to vaporize the fluid to form a haze.

2. The hazer of claim 1, further comprising:
an air inlet configured to attach to an air duct; and
a haze outlet configured to attach to the air duct;
wherein the controller is further configured to actuate the peristaltic pump in response to entry of air from the air duct through the air inlet.

3. The hazer of claim 1, further comprising:
a tube connecting the peristaltic pump and the heater; and
an air pump connected to the tube, wherein the controller is coupled to the air pump.

4. The hazer of claim 3, wherein the controller is further configured to adjust a rate of air flow from the air pump through the tube into the heater.

5. The hazer of claim 1, further comprising:
a fan including a tachometer;
wherein the controller is coupled to the tachometer.

6. The hazer of claim 5, wherein the controller is further configured to detect a fan error in response to a fan speed obtained from the tachometer.

7. The hazer of claim 5, further comprising:
a sponge positioned underneath the fan to catch fluid droplets from the fan.

8. The hazer of claim 1, further comprising:
a housing containing the peristaltic pump, the heater, and the controller; and
a power supply adapter external to the housing, wherein the controller is configured to measure voltage supplied by the power supply adapter.

9. The hazer of claim 1, further comprising:
a tube connecting the peristaltic pump and the heater; and
a pressure sensor coupled to the tube, wherein the controller is coupled to the pressure sensor.

10. The hazer of claim 9, wherein the controller is further configured to detect fluid entry from the peristaltic pump into the tube in response to information obtained from the pressure sensor.

11. The hazer of claim 1, wherein the heater includes a thermocouple, and wherein the controller is further configured to detect whether the thermocouple is open.

12. The hazer of claim 1, further comprising:
a fluid tank connected to the peristaltic pump, wherein the controller is further configured to determine a fluid level of the fluid tank based on pumping of the fluid in the peristaltic pump.

13. A method of controlling a hazer, comprising:
actuating a peristaltic pump to pump fluid from a fluid tank into a heater; and
causing the heater to vaporize the fluid to form a haze.

14. The method of claim 13, further comprising:
adjusting a rate of air flow from an air pump into a tube connecting the peristaltic pump and the heater.

15. The method of claim 13, further comprising:
configuring a fan with a set fan speed;
obtaining a fan speed from a tachometer in the fan; and
detecting a fan error in response to the fan speed being different than the set fan speed.

16. The method of claim 13, further comprising:
obtaining information from a pressure sensor coupled to a tube connecting the peristaltic pump and the heater; and
detecting fluid entry from the peristaltic pump into the tube in response to the information from the pressure sensor.

17. The method of claim 13, further comprising:
detecting whether a thermocouple in the heater is open.

18. The method of claim 13, further comprising:
determining a fluid level of the fluid tank, wherein the fluid tank is connected to the peristaltic pump.

19. A system comprising:
one or more hazers each including:
a peristaltic pump; and
a heater;
and
a controller coupled to the one or more hazers;
wherein the controller is configured, for each of the one or more hazers, to actuate the peristaltic pump to pump fluid into the heater, and to cause the heater to vaporize the fluid and form a haze.

20. The system of claim 19, further comprising:
an air duct, wherein the one or more hazers each include an air inlet attached to the air duct and a haze outlet attached to the air duct;
wherein the controller is further configured, for each of the one or more hazers, to actuate the peristaltic pump in response to entry of air from the air duct through the air inlet.

21. The system of claim 19, wherein the one or more hazers comprise a master hazer and a slave hazer, and wherein the master hazer is coupled to the controller and the slave hazer is coupled to the master hazer.

22. The system of claim 19, wherein the controller is further configured to communicate with each of the one or more hazers via a first digital multiplex (DMX) channel and via a second DMX channel, and wherein the controller is configured to set a hazer mode through the first DMX channel and to communicate data associated with the hazer mode through the second DMX channel.
